(19) United States
(12) Patent Application Publication
(10) Pub. No.: US 2026/0206001 A1
(43) Pub. Date: Jul. 16, 2026

(54) PRECISE POSITIONING SYSTEM INCLUDING RF BEACONS

(71) Applicant: TechNickel, Inc., Pacifica, CA (US)

(72) Inventors: Janice H. Nickel, Pacifica, CA (US); Jacob Stauber, Evans, GA (US)

(21) Appl. No.: 19/020,079

(22) Filed: Jan. 14, 2025

(51) Int. Cl. H04W 64/00; H04B 17/318; H04W 24/10

(52) U.S. Cl. CPC H04W 64/006; H04B 17/318; H04W 24/10

(57) ABSTRACT

A method of creating a precise positioning system includes deploying a plurality of RF beacons at a site. Each RF beacon includes an inertial measurement unit (IMU) and an RF transceiver. The method further includes recording a deployment location for each RF beacon that is deployed, and commanding the IMU of each RF beacon to begin measuring drift upon deployment. For each RF beacon, the RF transceiver is configured to transmit a drift measurement in response to an interrogator signal.

### BACKGROUND

Global Positioning System (GPS) is a widely-used satellite-based navigation radio system that provides position, navigation, and timing information to end users. In certain environments, however, GPS service is not available, or it is degraded to the point of being unusable.

### BRIEF DESCRIPTION OF THE DRAWINGS

FIG. 1 is an illustration of certain features of an RF beacon.

FIG. 2 is an illustration of a method for deploying a plurality of RF beacons at a site.

FIG. 3 is an illustration of a method of using a plurality of RF beacons situated at a site.

FIGS. 4A and 4B are illustrations of RF beacons that have been deployed and situated at a site.

FIG. 5 is an illustration of certain features of an enhanced RF beacon.

FIG. 6 is an illustration of certain features of an end user device configured to use a plurality of situated RF beacons.

FIG. 7 is an illustration of certain features of a system for deploying and using a plurality of RF beacons at a site.

FIG. 8 is an illustration of a method performed by the system of FIG. 7.

### DETAILED DESCRIPTION

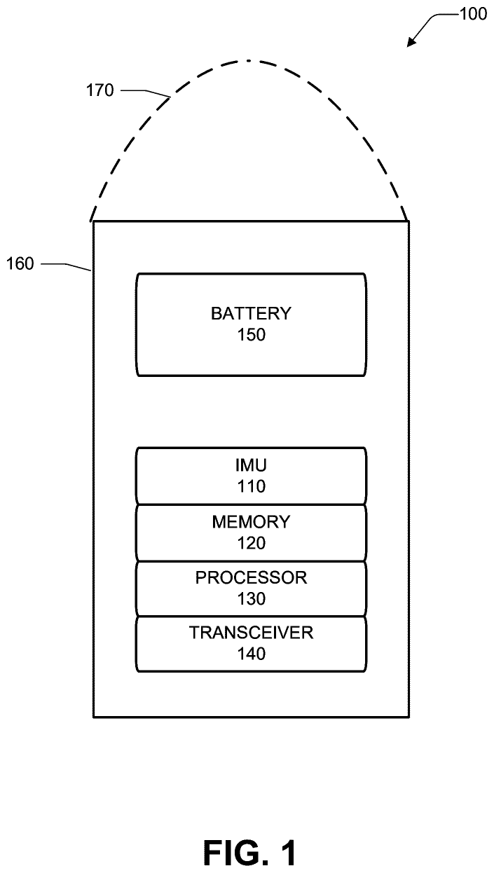

Reference is made to FIG. 1, which illustrates an RF beacon 100. The RF beacon 100 includes an inertial measurement unit (IMU) 110, memory 120, a processor 130, a radio frequency (RF) transceiver 140, and a battery 150, all within a housing 160. In some embodiments, the IMU 110, the memory 120, the processor 130 and the transceiver 140 are packaged as separate chips, which may be stacked (as illustrated in FIG. 1) or surface mounted to a printed circuit board. The chips may be interconnected by vias or by an external bus. In other embodiments, one or more application specific integrated circuits (ASICs) or systems-on-chip (SoC) includes the IMU 110, the memory 120, the processor 130 and the transceiver 140.

The IMU 110 may be a strapdown type that includes micro-electromechanical systems (MEMS) accelerometers and MEMS gyroscopes. The accelerometers measure linear acceleration along orthogonal x, y and z axes, and the gyroscopes measure angular velocity about the x, y and z axes. The accelerometers may also be used to determine a local gravity vector.

The IMU 110 also includes a MEMS vector magnetometer that measures both magnitude and direction of the total magnetic field. Three orthogonal sensors may be used to measure components of the magnetic field along three orthogonal axes. The measurements may be used to determine bearing, which may be calculated as an angle measured in degrees in a clockwise direction from true north.

Considerations for the IMU 110 include accuracy, robustness against shock, vibration, noise and interference, cost, and weight. These considerations are specific to the environment in which the RF beacon 100 will be deployed.

The memory 120 stores information such as a unique beacon identifier, which can be a unique code. The memory 120 also stores drift measurements. A portion of the memory 120 that stores the beacon identifier may be write-once, read-many (WORM) memory for anti-tampering purposes.

The transceiver 140 may, in some embodiments, be similar to the transceiver of an RFID tag, which is configured to receive an interrogator signal and broadcast a response signal via an antenna (not shown). However, the transceiver 140 is not limited to any particular wireless technology. Wireless technologies may include xG (x=3,4,5, and any future versions) and/or WiFi or Bluetooth or other wireless communication.

Standard radio frequencies for the transceiver 140 may include the following. UHF 918-928 MHz has 50 channels with 4 W effective radiative power and a 12 meter range. UHF low end 433 MHz has a broadcast range between 1-100 meters. UWB 3.1-10 GHz has a 200 m broadcast range. Other frequencies for the transceiver 140 may include Microwave (regulated) 24.50-2.45 GHZ (in low data mode) and WiFi and Bluetooth frequencies. Non-standard radio and microwave frequencies may also be used.

The transceiver 140 may be configured to transmit via one or more preprogramed downlinks and one or more power levels. The transceiver 140 may be configured to receive an interrogator signal or other signal via one or more preprogrammed uplinks and one or more power levels. Standard or non-standard power levels may be used.

The battery 150 supplies operating power to the IMU 110, the memory 120, the processor 130, and the transceiver 140. Battery usage may be reduced if the transceiver 140 is a passive or semi-passive device that receives power from an interrogator signal. If the transceiver 140 is semi-passive, the battery 150 may be used to provide additional power upon interrogation in order to boost broadcast range.

The RF beacon 100 may be turned on prior to deployment (e.g., mechanically or though software). Power is supplied to the memory 120, the processor 130 and the transceiver 140.

The processor 130 may be configured to process external commands. A first command may may be issued shortly prior to deployment to cause the processor 130 to power on the IMU 110 and warm up. During warm up, the IMU's sensors stabilize, and settings such as sampling rate and measurement ranges are configured. The processor 130 may zero out any drift measurements stored in memory 120. The IMU 110 may also perform self-calibration to determine drift error. A second command may be issued upon deployment to cause the processor 130 to command the IMU 110 to start measuring drift.

The processor 130 processes data from the IMU 110. The IMU 110 outputs accelerometer raw data (accelerations) in the x, y and z directions. In some embodiments, the raw data may be stored in memory 120 and used later to determine drift. In other embodiments, the accelerations are integrated to give velocity, and integrated again to give translations Δx, Δy and Δz along the x, y and z axes. Sensor fusion may be performed to achieve accurate and stable orientation measurements. For instance, Kalman filters or complementary filters may be used to merge the measurements.

The magnetometer measures magnetic and direction of field strength, which enables bearing to be determined. Let 0 be the bearing angle, which is measured in degrees in a clockwise direction from true north. Let D be the distance traveled in the plane orthogonal to the gravity vector. The processor 130 can compute changes in latitude and longitude as ΔLat=D×cos(θ) and ΔLong=D×sin(θ). The change in elevation may be computed as the distance traveled along the gravity vector.

In some embodiments, the IMU 110 has a dynamic data sampling rate. While the IMU 110 is relatively stationary (e.g., upon being situated, as described below), it has a low data rate. When the accelerometer has an increase in magnitude (e.g., while the RF beacon 100 is falling to the ground, or is moved after reaching the ground), the data rate is increased.

When the transceiver 140 receives an interrogator signal, it notifies the processor 130 (e.g., via an interrupt), and the processor 130 encodes the unique beacon identifier and the drift and bearing measurements into a response signal. The processor 130 then causes the transceiver 140 to broadcast the response signal.

The uplink and downlink frequencies and power levels may be programmed before, during, or after deployment. Phase and modulation may also be defined before, during, or after deployment.

In some embodiments, the housing 160 may be camouflaged so that the RF beacon 100 is not disturbed after it has been situated. For instance, the housing 160 may have a shape and color that mimics rocks or other objects at the site where the RF beacon 100 will be situated so it is not picked up or otherwise moved by people or animals. If aerodynamics is a concern, the housing 160 may be fitted with a nose cone 170 or other means that improves stability upon being dropped. In some embodiments, the housing 160 may be configured to be biased towards a preferred orientation (e.g., upright) when the RF beacon 100 is situated. The battery 150 may be placed in or near the nose cone 170 to weight the RF beacon 100.

The housing 160 is preferably made of a material that is RF transparent to incoming and outgoing RF signals. If the RF beacon 100 is dropped during deployment, the housing 160 should have the toughness and ductility to withstand impact and protect the components within. In some embodiments, the body may be made of a material that absorbs the shock of impact. For example, the body and/or nose cone may be made of multiple layers of a mechanical metamaterial that sequentially buckles. A metamaterial such as 316L stainless steel has a very small ratio between tangent modulus (about 500 MPa) and elastic modulus (about 200 GPa) and a relatively high yield stress of about 500 MPa. A layer will buckle, followed by a positive stiffness after buckling. Progressive collapse of the nose cone 170 and upper portion of the housing 160 provides an efficient shock-absorbing mechanism. Sequential buckling of metamaterials is described in greater detail in Wenfeng Liu et al., “Harnessing plasticity in sequential metamaterials for ideal shock absorption” published online on 16 Oct. 2024 at https://doi.org/10.1038/s41586-024-08037-0.

If the housing 160 does not have the toughness and ductility to withstand impact and protect the components within, or if a soft landing is desired, the nose cone 170 may contain a parachute to reduce the force of impact on landing. The parachute may be made of easily biodegradable material or it may be made of a material that acts as camouflage for the RF beacon 100.

The housing 160 may further be equipped with an attachment mechanism (not shown). For instance, the nose cone 170 may have a spike-like shape instead of a rounded shape. If the RF beacon 100 is dropped onto a relatively soft surface, the spike-like shape can penetrate the soft surface. If the RF beacon 100 is situated on a harder object or an upright object, the housing 160 may be covered with an adhesive.

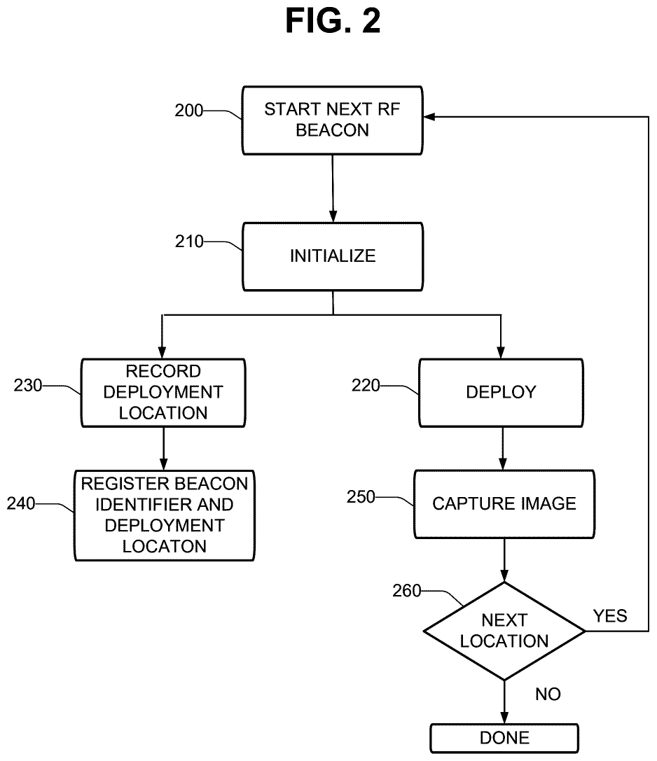

Reference is now made to FIG. 2, which illustrates a general method of using a plurality of the RF beacons 100 to create a precise positioning system at a site. The site may be on land or water, or it may be subterranean. An on-land site is not limited to any particular type of terrain. Examples of terrains include, but are not limited to, plateaus, mountains, plains, valleys, canyons, cirques, foothills, dry lake beds, dunes, forests, and marsh lands. As for the site being a sea or other body of water, RF beacons 100 may be deployed on flotation devices such as buoys.

In FIG. 2, the plurality of RF beacons 100 may be deployed one at a time. In other embodiments, however, more than one RF beacon 100 may be deployed at any given time.

At block 200, an RF beacon 100 is commanded to start. Once the RF beacon 100 has started, its memory 120 becomes accessible.

At block 210, the RF beacon 100 is initialized. Initialization includes setting drift along the x, y and z axes to initial values (e.g., Δx=0, Δy=0, and Δz=0). The initialization also includes reading the beacon identifier from the memory 120.

At block 220, the RF beacon 100 is deployed. Depending upon the mode of deployment, the RF beacon 100 might be placed at the location or dropped above the location or otherwise transported to its location. As a first example, an aerial vehicle (e.g., UAV, helicopter) drops the RF beacon 100. As a second example, a land-based vehicle places the RF beacon 100. As a third example, a person places the RF beacon 100 at its location. As a fourth example, a flotation device transports the RF beacon 100 to its location on a body of water.

At block 230, the deployment location of the RF beacon 100 is recorded. If a GPS system is available, GPS coordinates are recoded to indicate the deployment location. If the site is exposed to high Electromagnetic Interference (EMI), which denies or degrades GPS service, another approach may be used. For instance, dead reckoning may be performed to determine the deployment location. A high precision IMU may measure movement of the deployment vehicle from a known fixed reference location to determine the location at which the RF beacon is deployed. If a person places the RF beacon 100 at its location, that person may use a handheld device to obtain location coordinates.

The IMU 110 is commanded to measure drift from the deployment location. If the RF beacon 100 is dropped, the IMU 110 measures drift from the deployment location to the location where the RF beacon 100 is situated. If the RF beacon 100 is placed, there will be no drift to measure. However, the IMU 110 will measure any subsequent movement.

At block 240, the beacon identifier and the recorded location are registered. For example, a signal conveying the recorded location and the beacon identifier is transmitted to a remote facility, which stores the recorded location and the beacon identifier as an entry in a database. Although shown as being performed in real time, the recorded location may be registered off-line. For instance, the recorded location and the beacon identifier could be stored in local memory on the deployment device, and contents of the local memory could be transferred to the remote facility after the deployment has been completed. (End user devices will later retrieve this information from the remote facility).

In the embodiments described above, the registered location is the deployment location. In other embodiments, the registered location is the location of the RF beacon after it has been situated (the in-situ location). Consider an RF beacon 100 that is dropped at a deployment location and measures drift from the deployment location to an in-situ location. The RF beacon 100, after being situated, is commanded to return a drift measurement, the drift measurement is added to the deployment location to produce the in-situ location, and the in-situ location is registered. The database may have a field for indicating whether the registered location is the deployed location or the in-situ location.

In addition to the functions above, if an RF beacon is visible after being situated, an image of the RF beacon may be captured (block 250). This image may also be communicated to the remote facility. The situated position of the RF beacon 100 in the overlaid image may be compared to images that have exact location data (e.g., images from a mapping service). That exact location data may replace the in-situ location stored in the database. The field may be expanded to indicate whether the registered location is the deployed location, or the in-situ location, or the location derived from comparison of images.

At block 260, another location is visited, and control is returned to block 200. This continues until the last of the RF beacons 100 has been deployed.

In some embodiments, multiple deployment vehicles may be used in parallel to deploy the RF beacons 100. In some embodiments, the RF beacons 100 may be deployed ballistically. Parachutes may be deployed to slow vertical descent.

The RF beacons 100 on the site are not limited to any particular pattern. As a first example, the RF beacons 100 may be placed at corners of cells of a grid. As a second example, the RF beacons 100 may be randomly scattered about the site.

Density/separation of the RF beacons 100 depends on the broadcast range of the transceivers 140. Optimally, any point on the site should be in RF communication range of at least three RF beacons 100.

The method of FIG. 2 creates a positioning system that can be deployed quickly and imprecisely, yet provides still sub-meter position accuracy. The positioning system can operate in environments and situations where GPS is denied or degraded (e.g., major solar flares, and high EMI environments). The positioning system can operate in visually-obscured environments (e.g., night time, smoke, rain, snow, etc.).

The RF beacons 100 are relatively low in cost. They are relatively tamper-proof and free from spoofing. They may use non-standard frequencies that don't interfere with GPS and other standard frequencies, or they may use non-standard frequences that are difficult to discern from the noise floor (the level of unwanted background noise when no significant signal is being transmitted) or background electromagnetic fields.

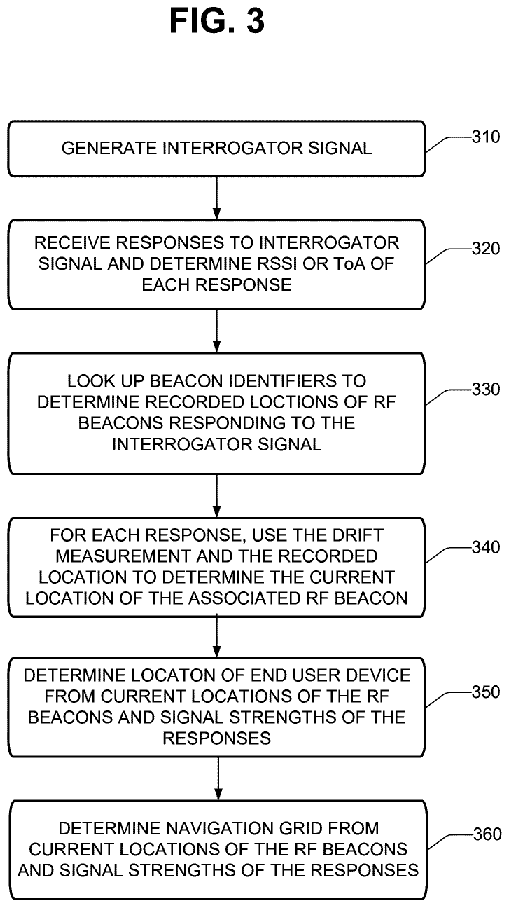

Reference is now made to FIG. 3, which illustrates a general method of using the positioning system after the RF beacons have been deployed and situated at a site. The method will be described in connection with an end user device. The end user device is located somewhere on the site. The end user device attempts to determine its exact position on the site.

At block 310, the end user device generates an interrogator signal. Responses are generated by all RF beacons that receive the interrogator signal.

At block 320, the end user device receives response signals from all RF beacons within range of the interrogator signal. The end user device reads a beacon identifier and a drift measurement from each response signal.

Also at block 320, strength of each response signal is determined. For instance, a received signal strength indicator (RSSI) may be computed. RSSI is a measurement of power present in the received signal. That measurement is proportional to distance from its RF beacon to the end user device. Alternatively, the end user device may use Time of Arrival (ToA) of the received signal to determine the distance to the RF beacon.

At block 330, the end user device looks up the beacon identifier in each response signal to determine the registered locations of the RF beacons sending the response signals. For instance, the end user device can communicate with the remote facility and request the registered location corresponding to each beacon identifier. In the alternative, the end user device can store a table in local memory. The table contains the beacon identifiers and recorded locations of some or all of the RF beacons at a site. Prior to entering the site, the end user device loads the table into local memory. The end user device looks up the recorded locations in the local memory. This alternative approach is advantageous in a high EMI environment, where communications with the remote facility might be jammed.

In the embodiments described above, an RF beacon 100 stores a unique identifier and sends the unique identifier to end user devices. In other embodiments, an RF beacon may store its in-situ location in memory 120 instead of the unique identifier. In those embodiments, the in-situ location is transmitted to the end user device upon interrogation, thereby eliminating the steps of the end user device communicating with the remote facility and accessing a location associated with a unique identifier.

At block 340, the end user device uses the drift measurement and the recorded location of the RF beacon to determine the current location of the RF beacon. If the RF beacon is moved after its situated location is recorded, the drift measurement may indicate the magnitude and direction of movement, or it may indicate components Δx, Δy and Δz of the drift measurement. The drift measurement can be added to or subtracted from the registered location.

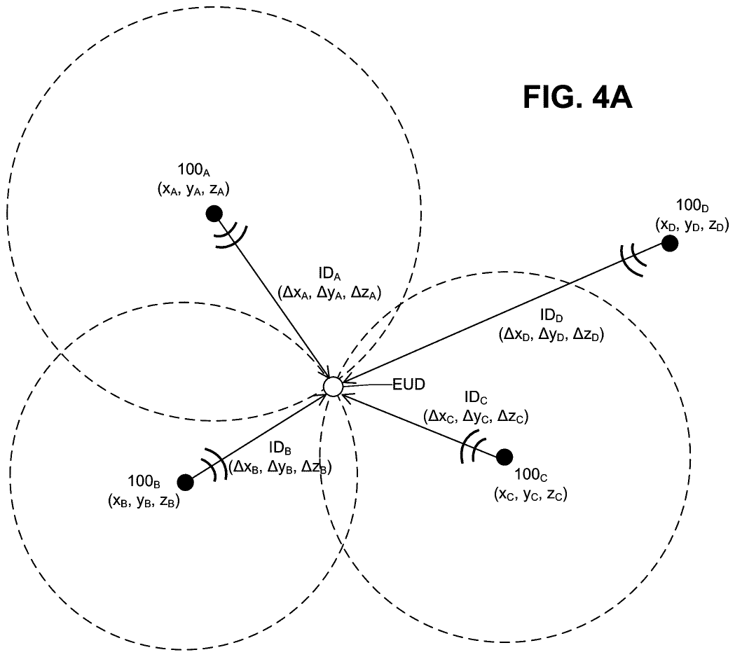

At block 350, the end user device determines its location from the current locations of the RF beacons, and signal strengths of the RF beacons. FIG. 4A provides an example.

At block 360, a navigation grid is determined from the RF beacons. The navigation grid may be created by the end user device, and/or it may be created at the remote facility. FIG. 4B provides an example.

Additional reference is made to FIG. 4A, which illustrates an example of an end user device (EUD) determining its position from four RF beacons 100_{A}, 100_{B}, 100_{C}, and 100_{D} that responded to an interrogator signal. After the end user device receives the responses to the interrogator signal, it looks up the beacon identifiers and corresponding registered locations, and adds drift measurements IDA, ID_{B}, ID_{C} and ID_{D} to determine the current positions of the RF beacons. The current positions of the RF beacons are denoted as (x_{A}, y_{A}, z_{A}), (x_{B}, y_{B}, z_{B}), (x_{C}, y_{C}, z_{C}), and (x_{D}, y_{D}, z_{D}). The end user device also uses RSSI or ToA of the four responses to determine distance to each RF beacon 100_{A}, 100_{B}, 100_{C}, and 100_{D}.

Given this information, the EUD may perform trilateration or multilateration to determine its position. Consider trilateration with the RF beacons 100_{A}, 100_{B}, and 100_{C}. The EUD lies at the intersection of semi-spheres (represented by circles) about the RF beacons 100_{A}, 100_{B}, 100_{C}. Let r_{A} be the distance from RF beacon 100_{A} to the EUD, rs be the distance from RF beacon 100_{B} to the EUD, and r_{C} be the distance from RF beacon 100_{C}. Now let x₀, y₀, z₀ be the current position of the EUD. The following three equations have three unknows (x₀, y₀, z₀).

$${( {x}_{0} - {x}_{A} )}^{2} + {( {y}_{0} - {y}_{A} )}^{2} = {r}_{A}^{2}$$

$${( {x}_{0} - {x}_{B} )}^{2} + {( {y}_{0} - {y}_{B} )}^{2} = {r}_{B}^{2}$$

$${( {x}_{0} - {x}_{C} )}^{2} + {( {y}_{0} - {y}_{C} )}^{2} = {r}_{C}^{2}$$

These three equations can be solved algebraically or numerically to determine the current position of the EUD. If the fourth RF beacon 100_{D} is also used (multilateration instead of trilateration), accuracy of the current position of the EUD can be increased through least squares optimization.

Additional reference is made to FIG. 4B, which illustrates an example of additionally using a map 450 and the four RF beacons 100_{A}, 100_{B}, 100_{C}, and 100_{D} to create a navigation grid. The precise locations of the RF beacons 100_{A}, 100_{B}, 100_{C}, and 100_{D} are shown on the map 450. The location of the EUD, having been determined by trilateration, is also shown on the map 450.

The x-coordinate of each RF beacon 100_{A}, 100_{B}, 100_{C}, and 100_{D} corresponds to a latitudinal position, the y-coordinate corresponds to a longitudinal position, and the z-coordinate corresponds to altitude. The magnetometer in the IMU of each RF beacon 100_{A}, 100_{B}, 100_{C}, and 100_{D} orients the position of the x, y and z axes relative to the earth.

The current locations of the RF beacons 100_{A}, 100_{B}, 100_{C}, and 100_{D} are used to create a navigation grid on a map. The grid of FIG. 4B is formed by lines of latitude and longitude. A line of latitude Lat_1 may be placed as follows. For example, it may be desired to place a line of latitude Lat_1 at 38 degrees, 10 minutes. If the x-coordinate (x_{B}) of RF beacon 100_{B} is 38 degrees, 16 minutes and 32 seconds, then the point P_{B,Lat_1} on line Lat_1 is ΔY_{B-Lat_1}=6 minutes, and 32 seconds south of the RF beacon 100_{B}. Similarly, the point P_{C,Lat_1} is ΔY_{C-Lat_1} north of RF beacon 100_{C}, and P_{D,Lat_1} is ΔY_{D-Lat_1} south of RF beacon 100_{D}. Given this information, the position of line Lat_1 is interpolated from a linear regression of the points P_{B,Lat_1} P_{C,Lat_1} and P_{D,Lat_1}. Line of latitude Lat_2 may be interpolated from the point that is ΔY_{A-Lat_2} south of RF beacon 100_{A}, the point that is ΔY_{B-Lat_2} north of RF beacon 100_{B}, and the point that is ΔY_{D-Lat_2} north of RF beacon 100_{D}.

Line of longitude Long_1 is computed in a similar manner. Long_1 is interpolated from two points: the point that is ΔX_{B-Long_1} east of RF beacon 100_{B}, and the point that is ΔX_{A-Long_1} east of RF beacon 100_{A}. Long_3 is interpolated from two points: the point that is ΔX_{C-Long_3} east of RF beacon 100_{C}, and the point that is ΔX_{D-Long_3} west of RF beacon 100_{D}.

The accuracy of the linear regression depends on the number of points and the uncertainty in the positions of the RF beacons. For the sparse beacon distribution shown in FIG. 4B, there is only one nearby point to Long_2, so Long_2 relies on inferences from Long_1 and Long_3 (e.g., Long_2 parallel to Long_1 and Long_3). By adding more RF beacons to the site and, therefore, a greater number of points P to perform a regression, the grid lines may be determined more accurately.

A grid herein is not limited to the latitudinal/longitudinal grid of FIG. 4B. In other embodiments, the grid may utilize a Military Reference Grid System or an independent grid configuration for position and navigation purposes.

The end-user device can then use its position and the grid to navigate the site without GPS. For end user devices with human interfaces, the grid may be superimposed on images of the site. More accurate navigation is enabled since not only is the position of the EUD known, but the grid positions are also known.

As the end user device continues to move along the site, position of the end user device is updated. In some embodiments, control can be returned to block 310, where another position is computed. An interrogator signal is transmitted and nearby RF beacons provide response signals. If the same RF beacons are responding to the interrogator signals, then blocks 330 and 340 can be skipped, and trilateration may be performed with an updated RSSI or Time of Arrival measurements.

As the end user device moves across the site and performs trilateration on additional response signals, the series of trilaterations not only provides an serially-updated accurate locations and heading but also a provides circular error probable (CEP). As each additional trilateration is performed, the CEP becomes smaller and smaller due to the additional reference points.

In other embodiments, the end user device may have an IMU or other sensor platform for computing changes in the x-, y- and z-directions. Instead of returning control to block 310, the end user device may perform dead reckoning to update its position. Control can be periodically returned to block 310 to update the precise location of the end user.

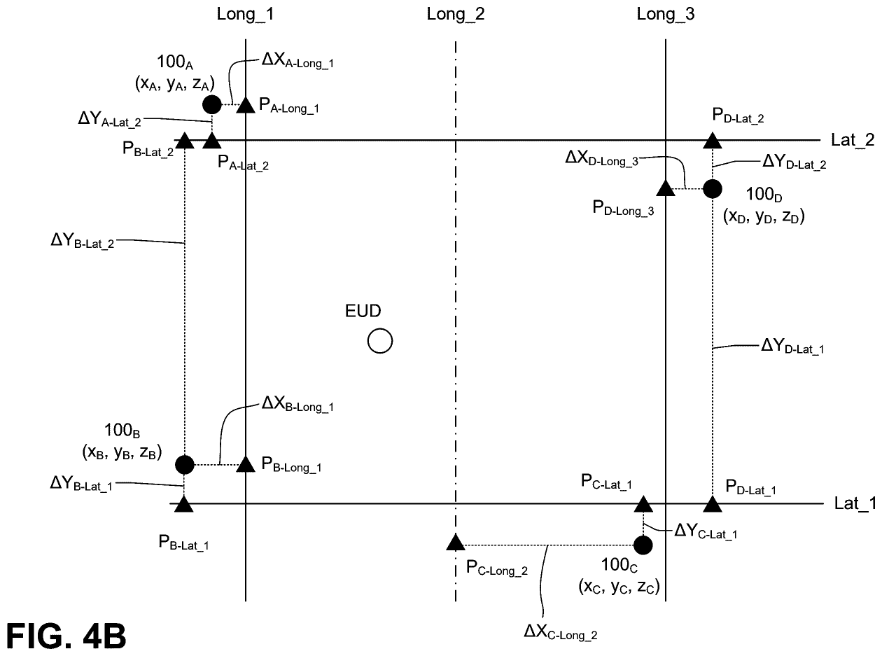

An RF beacon herein is not limited to the example illustrated in FIG. 1. Another example is illustrated in FIG. 5.

Reference is now made to FIG. 5, which illustrates an RF beacon 500 including an IMU 110, memory 120, processor 130, an RF transceiver 140, and a battery 150. The RF beacon 500 further includes a power amplifier 510, and a Multi Frequency (MF) antenna 520 capable of broadcasting at multiple frequencies. Examples of the MF antenna 520 include a Multiple Input Multiple Output (MIMO) antenna and a fractal antenna. The IMU 110, memory 120, processor 130, RF transceiver 140, battery 150 and power amplifier 510 are mounted within a housing 530. The MF antenna 520 may be mounted within the housing 530 or external to the housing 530.

The RF transceiver 140 is configured to transmit at a base frequency. The power amplifier 510 may boost the base frequency to at least two additional transmission frequencies. RF signals at the different frequencies all carry the same information, including beacon identifiers and drift measurements.

In some embodiments, the signals at the different frequencies are broadcasted at the same time by the MF antenna 520. In other embodiments, the processor 130 has an additional mode of operation, in which it can select one of the frequencies for broadcast. The signal is broadcasted at the selected frequency by the MF antenna 520.

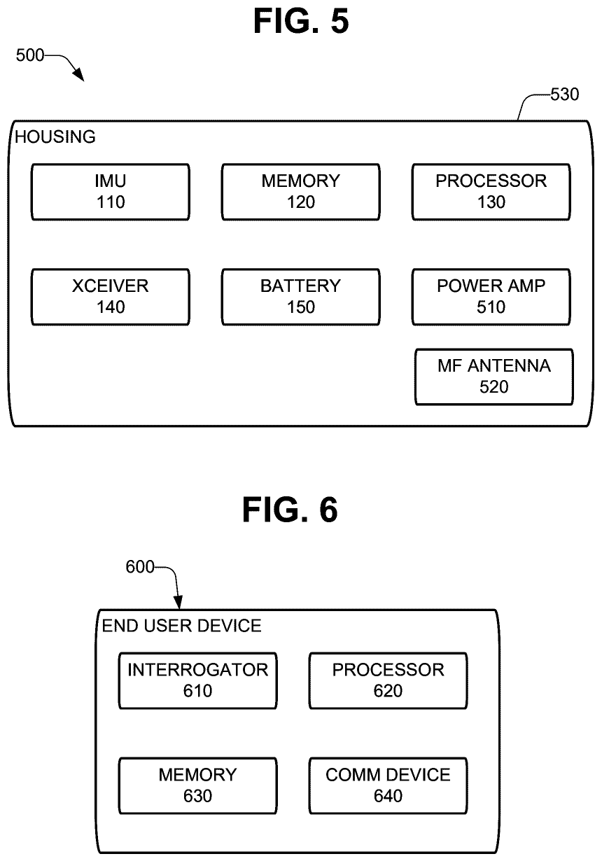

Reference is made to FIG. 6, which illustrates an end user device 600 for determining its position from a plurality of RF beacons that are situated at a site. The end user device 600 includes an interrogator 610 that is configured to broadcast an interrogator signal, receive RF response signals, and determine RSSI or ToA of each response signal.

The end user device 600 further includes a processor 620 configured to read a beacon identifier and drift measurement in each response signal, look up registered positions of RF beacons corresponding to the beacon identifiers, and use the RSSI, drift measurements and recorded positions to determine a current location of the end user device 600.

The end user device 600 may include memory 630 for storing a table of beacon identifiers and corresponding registered locations. Instead or in addition, the end user device 600 may include a wireless communications device 640 for communicating with a remote facility (to transmit the beacon identifiers and receive the corresponding recorded positions).

In some embodiments, the end user device 600 receives the response signals at the different frequencies, and processes each response signal independently. For example, if an RF beacon broadcasts the same information at frequencies f1, f2 and f3, the end user device processes a response signal at frequency f1 independently, a response signal at frequency f2 independently, and a response signal at frequency f3 independently, even though these three response signals may convey the same information.

In some embodiments, the end user device 600 has an additional mode of operation for communicating with an RF beacon having a multi-frequency or multi-band RF transceiver. The multi-frequency transceiver is configured to accept multiple frequency inputs from an interrogator. In this additional mode, the end user device 600 is further configured to analyze EMI at the site, and choose an interrogator frequency that is not jammed and that is accepted by the transceiver. For instance, the processor 620 can sweep through a set of frequencies and analyze signal to noise ratio (SNR) at each frequency. An algorithm or a machine learning model may be used to select an uplink frequency and a downlink frequency at which the least amount of EMI in time/space/EMS is present. The interrogator signal is sent to the RF beacon at the selected downlink frequency. The selected uplink frequency may be encoded in the interrogator signal. The RF beacon receives and decodes the interrogator signal, and broadcasts at the selected uplink frequency.

In embodiments where a machine learning model is used to select uplink and downlink frequencies, the machine learning model may be trained on timing and spacing of EMI signals to select available frequencies at specific times. When used in battlefield situations, the machine learning model may also be trained on enemy and their capabilities in EMI space.

The ability to broadcast at multiple frequencies-frequency diversity-enables the system to provide precise positioning in an environment with heavy EMI. Even if multiple frequencies are jammed or saturated, a frequency may still be found for communication.

The frequency diversity also allows the transmissions by the RF beacons to blend in with the surrounding EMS environment and appear as normal commercial signals. The blending makes it harder to identify an RF beacon as an RF beacon. To an enemy observer on a battlefield, the RF beacon is just something that is chirping and should be ignored.

Frequency diversity offers other advantages. If the RF beacons transmit the same information in signals at multiple frequencies, and RSSI is computed for each signal, then more data points are created, whereby accuracy of the positioning estimates is improved.

The ability to select different uplink and downlink frequencies enables the system to be reconfigurable for different missions. This reconfigurability enables better spectrum utilization and de-confliction, and it makes it harder to employ countermeasures.

In some embodiments, the interrogator 610, the processor 620, and the memory 630 are mounted within a housing, which is mounted to a vehicle. In other embodiments, the interrogator 610 is added to a mobile device, such as a handheld device or a vehicle, and a processing unit of the mobile device is configured to perform the functions of the processor 620. Examples of the handheld device include, but are not limited to a laptop computer, tablet, and smartphone.

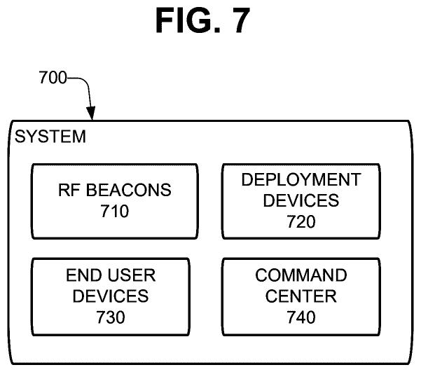

Reference is now made to FIG. 7, which illustrates an integrated system 700 including RF beacons 710 (any mix of the RF beacons 100 and 500), deployment devices 720, end user devices 730, and a command center 740. The deployment devices 720 may include any mix of manned vehicles (e.g., tanks, jeeps, cars, helicopters) and unmanned vehicles. However, deployment of the RF beacons 710 may be performed by means other than manned and unmanned vehicles. For instance, some or all of the RF beacons 710 may be deployed on foot. In some embodiments, some or all of the RF beacons 710 may be fired as projectiles onto a site. In view of significantly higher accelerations, the IMUs would be of a higher grade than IMUs of RF beacons that are dropped or placed.

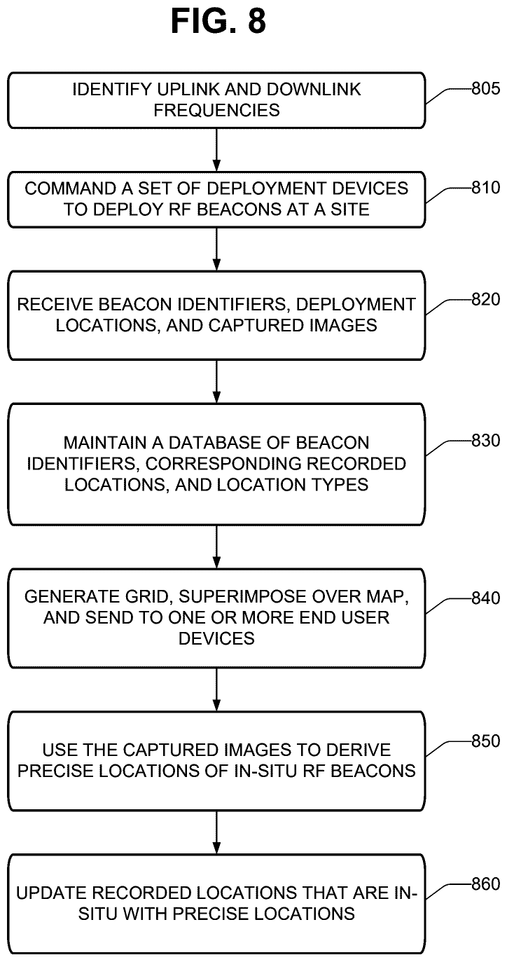

Reference is also made to FIG. 8, which illustrates a method performed by the command center 740. Before the RF beacons 710 are deployed by the deployment devices 720, the command center 740 may identify uplink and downlink frequencies (block 805). A machine learning model may be used to select multiple frequencies and power levels to optimize spectrum management. For example, the RF beacon 100 may be configured to transmit at two different frequencies and power levels and receive at two different frequencies and power levels to stay as close to the noise floor as possible, to conserve battery and to control the range and accuracy of the beacon signal.

The command center 740 is responsible for commanding the deployment devices 720 to deploy the RF beacons 710 at a site and gathering information about the site. For instance, the command center 740 may command a set of drones to deploy the RF beacons 710 at a site (block 810). From the deployment devices 720 at the site, the command center 740 receives beacon identifiers, recorded deployment locations, captured images of situated beacons at the site, and information about usable frequencies at the site (block 820). The command center 740 may also maintain a database of entries, where each entry includes an RF beacon identifier, a corresponding recorded location, and a flag indicating whether the recorded location is a deployment location or an in-situ location or a location derived from image comparisons (block 830). The command center 740 may generate the grid for the site, and that grid may be superimposed onto a map or image of the site and sent to one or more of the end user devices 730 (block 840). The command center 740 may also compare the captured images to images having precise location data (block 850). Those deployment locations that are in-situ may be updated with precise locations derived from image comparisons (block 860). The command center 740 may include one or more servers for performing these functions.

A system herein is not limited to any particular use case. The following use cases are provided as examples.

### Aerial and Ground Vehicle Navigation

The integrated system 700 may be used to ease navigation and improve safety for emerging uses such as aerial taxis and package delivery by drones. Since GPS can easily be jammed or spoofed, bad actors can easily pirate deliveries, and cause personal harm to riders of aerial taxis. The RF beacons 710 can be distributed in areas without navigational landmarks (e.g., expanses of dirt or trees) to improve the ability to maintain the correct course of the vehicles. The integrated system 700 can also provide GPS backup. In the event GPS is jammed or spoofed, the operator of the vehicle can take appropriate actions to greatly reduce the risk of pirates stealing packages or harming people. Maintaining RF beacons 710 on roadways as well as off road situations also provides improved safety for packages and riders.

### Mining and Underground

The geolocation of an object underground is highly problematic as GPS does not penetrate through the ground. The integrated system 700 can be used to map an underground tunnel or mine by using the location of the entrance or other nearby landmark as a reference point. The deployment devices 720 are equipped with high precision IMUs. The RF beacons 710 are deployed throughout the underground structure by either manned or unmanned vehicles. In some embodiments, there is a deployment device for each RF beacon, and each RF beacons is affixed to its deployment device. Each deployment position, determined from the known reference point and the output of the high precision IMU, is recorded and the beacon IMU is initialized.

An end user device may determine its underground geolocation by interrogating the RF beacons 710 to obtain the beacon identifiers, registered positions, and any drift measurement, and measuring their distance from the RF beacons 710.

### Farming

Farming is migrating toward autonomous operation. Autonomous tractors and other equipment may utilize centimeter GPS resolution when planting. However, solar flares can disrupt GPS, preventing precision planting of crops, and costing farmers substantial monetary losses. If GPS is disrupted, RF beacons 710 deployed at known positions on farmland can be used to provide highly accurate positioning data to precision farming equipment and other end user devices. For example, a tractor can interrogate the RF beacons 710 to determine their registered positions and any possible drift measurements. The tractor can further use either RSSI or ToA to determine positions of the RF beacons 710 relative to the tractor. In some embodiments, the RF beacons 710 may be configured with visible markers (e.g., reflective surfaces), and the tractor may be equipped with a LIDAR device to measure the positions of the RF beacons 710 relative to the tractor.

### Military

In battlefields that are exposed to high EMI environments, positioning and navigation of manned and unmanned vehicles are affected. RF beacons 710 situated in a battlefield enables combatants to establish position, and the grid enables more accurate targeting of enemy troops, gun installations, air strips and supply lines.

### Autonomous Enabled Airstrips and Taxiways

Autonomous airstrips require aerial vehicles to understand their location in all weather, lighting and EMI conditions. However, visual input might be degraded with fog, smoke, rain or snow. It might also be degraded by poor lighting conditions. Distance measurements might be degraded by rain and snow. GPS measurements might be degraded or denied in high EMI environments. A military airstrip might want to avoid the use of lights or radar to guide the vehicles in order maintain secrecy of the airstrip.

If an airstrip has a beacon system that cannot delineate the runway during adverse conditions (e.g., fog, countermeasures), the system 700 can be quickly deployed to provide location and navigation information in all weather, lighting and EMI conditions to enable positioning and navigation of manned or unmanned vehicles. The RF beacons 710 may or may not be positioned at boundaries of an airstrip. The aerial vehicles, autonomous or manned, may find the airstrip by periodically interrogating the RF beacons 710 at known frequencies used by the airstrip, looking up the deployment locations, adding any drift that occurred during deployment to determine current locations of the beacons, and performing trilateration to determine vehicle position relative to the airstrip. The RF beacons 710 may respond with a directional or omni directional signal. If the approach to the airstrip is known, it may be desirable to have the RF beacons 710 respond only in the direction of the approaching aircraft. If the airstrip needs to be discovered from any heading, then an omni directional signal may be used.

### Autonomous Vehicle Supply Lines

Military supply lines often traverse rugged terrain and improvised roads. The system 700 can be applied to autonomous vehicle supply lines that, for example, rely solely on a vehicle's computer vision system to navigate such roads. RF beacons 710 can be deployed at or near road boundaries. An autonomous vehicle traveling along a road can interrogate the RF beacons 710 at known downlink frequencies, receive RF beacon identifiers and drift data at known uplink frequencies, look up the deployment locations of the RF beacons 710, add any drift that occurred during and/or subsequent to deployment to determine the current positions of the RF beacons 710, and perform trilateration to determine position on the road. The supply lines may be run autonomously at night to protect it from enemy attack. The supply lines may also be run in inclement weather to maintain supplies.

### Minefield Identification and Path Clearance

Minefield clearance involves great difficulty and danger. The system 700 can reduce the difficulty and danger. For example, a specific pathway is chosen for clearance. RF beacons 710 are deployed throughout the minefield (for example, using ballistic distribution) including the specific path. The specific path is then cleared. Camouflaged RF beacons along and throughout the cleared path have their identifiers and positions registered in a database as belonging to the cleared path.

An end user device may interrogate the RF beacons 710 and get their identifiers, deployment position and drift, and whether it is along or within a cleared path. The cleared path can then be navigated with less danger. Other entities may interrogate the RF beacons 710, but will have no knowledge that certain RF beacons delineate a cleared path.

1. A method of creating a precise positioning system, comprising:
deploying a plurality of RF beacons at a site, each RF beacon including an inertial measurement unit (IMU) and an RF transceiver;
recording a deployment location for each RF beacon that is deployed; and
commanding the IMU of each RF beacon to begin measuring drift upon deployment;
wherein for each RF beacon, the RF transceiver is configured to transmit a drift measurement in response to an interrogator signal.

2. The method of claim 1, wherein the RF transceiver of each RF beacon is further configured to transmit a unique beacon identifier.

3. The method of claim 1, wherein the deploying includes dropping the RF beacons from a mobile platform and commanding each beacon to begin measuring drift upon being dropped.

4. The method of claim 3, wherein for deployment of a given RF beacon:
drift of the given RF beacon from start to end of deployment is measured;
the deployment location is adjusted for the drift measurement to produce an in-situ location; and
measured drift of the given RF beacon is reset.

5. The method of claim 3, wherein for deployment of a given beacon:
the deployment location and a unique beacon identifier are sent to a remote database.

6. The method of claim 1, wherein the RF beacons are deployed while the site is subject to high electro-magnetic interference.

7. The method of claim 1, wherein at least one aerial mobile vehicle is used to deploy the RF beacons.

8. The method of claim 1, wherein the RF beacons are deployed in a scatter pattern.

9. The method of claim 1, further comprising transmitting each beacon identifier and its corresponding recorded deployment location to a remote database for storage.

10. The method of claim 9, further comprising:
capturing images of the RF beacons after being situated at the site; and
transmitting the captured images to the remote database.

11. The method of claim 1, further comprising using the RF beacons, after being situated at the site, to create a navigation grid overlaid on a map of the site.

12. The method of claim 11, wherein creating the navigation grid includes
showing precise locations of the RF beacons on the map; and
creating grid lines on the map;
wherein creating a given grid line on the navigation grid includes:
calculating locations of at least two points on the given grid line as differences of positions of at least two beacons from the given grid line; and
performing a linear regression to delineate the given grid line.

13. A method of using the precise positioning system created according to claim 1, the method comprising:
broadcasting an interrogator signal from a location on the site;
receiving response signals to the interrogator signal;
using the response signals to determine distances from those RF beacons sending the response signals;
reading unique beacon identifiers and corresponding drift measurements in the response signals;
looking up recorded positions of the RF beacons corresponding to the beacon identifiers; and
performing trilateration or multilateration with the distances, drift measurements, and the recorded positions to determine coordinates of the location.

14. An RF beacon, comprising:
a housing;
memory within the housing, the memory encoded with a unique beacon identifier;
an inertial measurement unit (IMU) within the housing, the IMU including a vector magnetometer for computing a magnetic vector and orthogonal accelerometers for computing a gravity vector;
an RF transceiver within the housing; and
a processor within the housing, the processor configured to:
process raw data from the IMU to measure drift with respect to the magnetic vector and the gravity vector; and
in response to a command received by the transceiver, cause the transceiver to broadcast a signal encoded with the measured drift and the unique beacon identifier.

15. The RF beacon of claim 14, wherein the RF transceiver is configured to transmit the signal at a base frequency; wherein the RF beacon further comprises a Multi Frequency (MF) antenna and a power amplifier for boosting the base frequency to at least two additional transmission frequencies; and wherein the signal is broadcasted by the MF antenna at all of the frequencies.

16. The RF beacon of claim 14, wherein the RF transceiver is configured to transmit at a base frequency; wherein the RF beacon further comprises a Multi Frequency (MF) antenna and a power amplifier for boosting the base frequency to at least two additional transmission frequencies; and wherein the processor selects one of the frequencies for broadcasting the signal via the MF antenna.

17. The RF beacon of claim 14, wherein the RF transceiver is configured to transmit via one or more preprogramed downlinks and receive an interrogator signal via one or more preprogramed uplinks.

18. The RF beacon of claim 14, wherein the RF transceiver is configured to transmit and/or receive at multiple power levels.

19. The RF beacon of claim 14, wherein the housing and/or a nose cone are made of multiple layers of a mechanical metamaterial, wherein the multiple layers are designed to sequentially buckle upon impact.

20. An end user device, comprising:
an RF transceiver configured to wirelessly broadcast an interrogator signal, wirelessly receive response signals to the interrogation signal, and determine a distance from each response signal; and
a processor configured to read a beacon identifier and drift measurement in each response signal, look up recorded locations of RF beacons corresponding to the beacon identifiers, and use the distances, drift measurements and recorded locations to determine a location of the end user device.

21. The end user device of claim 20, wherein the transceiver is multi-band; and
the processor is further configured with a machine learning model trained on timing and spacing of EMI signals to analyze EMI at ambient conditions, and select an available uplink frequency and a downlink frequency subject to the EMI.

22. A system comprising:
a remote database;
a plurality of radio beacons, each radio beacon having a unique beacon identifier and including an inertial measurement unit configured to measure drift upon command, and a transceiver for broadcasting a signal upon command, the signal encoded with the unique beacon identifier and measured drift; and
at least one deployment device configured to carry and deploy the radio beacons, read a unique beacon identifier and record a corresponding deployment location for each radio beacon that is deployed, and communicate each radio beacon identifier and corresponding deployment location to the remote database.

23. The system of claim 22, further comprising an end user device including:
a transceiver and a processor configured to transmit interrogator signals, receive responses to the interrogator signals, determine distances from the responses, decode the responses to obtain beacon identifiers and drift measurements, communicate with the database to look up locations corresponding to the beacon identifiers, and use the locations, the distances, and the drift measurements to determine an end user device location.
